(19) United States
(12) Patent Application Publication
(10) Pub. No.: US 2026/0171559 A1
(43) Pub. Date: Jun. 18, 2026

(54) BATTERY CELL AND METHOD FOR MANUFACTURING THE SAME

(71) Applicant: SK On Co., Ltd., Seoul (KR)

(72) Inventor: Hyun Seok KIM, Daejeon (KR)

(21) Appl. No.: 19/422,484

(22) Filed: Dec. 17, 2025

(30) Foreign Application Priority Data
Dec. 17, 2024 (KR) 10-2024-0187972

(51) Int. Cl. H01M 50/105; H01M 10/04; H01M 50/178; H01M 50/54

(52) U.S. Cl. CPC H01M 50/105; H01M 10/0481; H01M 10/049; H01M 50/178; H01M 50/54

(57) ABSTRACT

The present disclosure relates to a battery cell. The battery cell includes an electrode assembly, and a pouch case. The pouch case includes: a first opposed surface and a second opposed surface facing each other in a first direction; a first connection portion and a second connection portion disposed in a second direction and connecting the first opposed surface and the second opposed surface; and a first extension portion and a second extension portion, and the first extension portion extends from the first connection portion and the second connection portion, and the second extension portion extends from the first connection portion and the second connection portion. A distance from the first connection portion to the second connection portion in a third direction is greater than or equal to a length of the first extension portion in the third direction.

### CROSS-REFERENCE TO RELATED PATENT APPLICATION

The present disclosure claims priority under 35 U.S.C. § 119(a) to Korean patent application number 10-2024-0187972, filed on Dec. 17, 2024, the entire disclosure of which is incorporated herein by reference.

### BACKGROUND OF THE INVENTION

### 1. Field

Various embodiments of the present disclosure generally relate to a battery cell and a method for manufacturing the same.

### 2. Description of the Related Art

A pouch-type secondary battery may be classified as a three-side sealed pouch-type battery cell or a four-side sealed pouch-type battery cell depending on the number of sealed sides.

In a three-side sealed pouch-type battery cell, opposite ends of an unsealed side may have a protruding shape. This is generally referred to as a “shark-fin” or “bat ear.”

However, due to the aforementioned protruding shape, a concern of reducing the energy density during a manufacturing of a battery module or a battery pack occurs.

### SUMMARY OF THE INVENTION

According to one aspect of the present disclosure, the problem to be solved is to improve the stability of a battery cell.

According to another aspect of the present disclosure, the problem to be solved is to improve the energy density of a battery cell.

According to another aspect of the present disclosure, the problem to be solved is to improve the efficiency of a battery cell.

According to another aspect of the present disclosure, the problem to be solved is to reduce a manufacturing cost of a battery cell.

According to another aspect of the present disclosure, the problem to be solved is to reduce a manufacturing cost of a battery module.

According to another aspect of the present disclosure, the problem to be solved is to reduce a manufacturing cost of a battery pack.

According to another aspect of the present disclosure, the problem to be solved is to improve the space utilization of a battery module.

According to another aspect of the present disclosure, the problem to be solved is to improve the space utilization of a battery pack.

Various embodiments of the present disclosure may be widely applied in the green technology fields such as electric vehicles, battery charging stations, energy storage systems (ESSs), and other technologies using batteries such as photovoltaics and wind power. In addition, various embodiments of the present disclosure may also be used for eco-friendly mobility, including electric and hybrid vehicles, to reduce air pollution and greenhouse gas emissions to prevent or mitigate climate change.

A battery cell according to an embodiment of the present disclosure may include: an electrode assembly in which a first electrode, a second electrode, and a separator separating the first electrode and the second electrode are stacked in a first direction; a pouch case accommodating the electrode assembly; and a first lead tab portion and a second lead tab portion electrically connected to the electrode assembly, and each protruding outwardly from the pouch case in a second direction which is one of directions perpendicular to the first direction. The pouch case may include: a first opposed surface and a second opposed surface facing each other in the first direction; a first connection portion and a second connection portion disposed in the second direction and connecting the first opposed surface and the second opposed surface; and a first extension portion and a second extension portion, wherein the first extension portion extends from the first connection portion and the second connection portion to enclose the first lead tab portion protruding in the second direction, and the second extension portion extends from the first connection portion and the second connection portion to enclose the second lead tab portion protruding in the second direction. A distance from the first connection portion to the second connection portion in a third direction perpendicular to the first direction and the second direction may be greater than or equal to a length of the first extension portion in the third direction.

In an embodiment, each of a minimum distance between the first connection portion and the first extension portion in the third direction, and a minimum distance between the second connection portion and the first extension portion in the third direction may be 10 mm or less.

In an embodiment, the first extension portion, the second extension portion, and the second connection portion may be sealed.

In an embodiment, the first opposed surface, the second opposed surface, and the first connection portion may be formed by folding a pouch sheet.

In an embodiment, the pouch case may further include: a first step portion connecting the first extension portion and the first opposed surface; and a second step portion connecting the first extension portion and the second opposed surface.

In an embodiment, an angle formed between the first step portion and the first opposed surface may be a right angle, and an angle formed between the second step portion and the second opposed surface may be a right angle.

A method for manufacturing a battery cell according to an embodiment of the present disclosure may be provided. The battery cell may include an electrode assembly in which a first electrode, a second electrode, and a separator separating the first electrode and the second electrode are stacked in a first direction; a pouch case accommodating the electrode assembly; and a first lead tab portion and a second lead tab portion electrically connected to the electrode assembly, and each protruding outwardly from the pouch case in a second direction which is one of directions perpendicular to the first direction. The method for manufacturing the battery cell may include: folding a pouch sheet along an imaginary folding line extending in the second direction, wherein a first opposed surface and a second opposed surface facing each other in the first direction are formed by folding the pouch sheet; forming a first extension portion which encloses the first lead tab portion protruding in the second direction and a second extension portion which encloses the second lead tab portion protruding in the second direction; forming a first connection portion and a second connection portion which connect the first opposed surface and the second opposed surface by stretching the pouch sheet in a third direction perpendicular to the first direction and the second direction, wherein a distance from the first connection portion to the second connection portion in the third direction is greater than or equal to a length of the first extension portion in the third direction; and inserting the electrode assembly into the pouch case.

In an embodiment, forming the first extension portion and the second extension portion may include pressing, by a first pressing member and a second pressing member, regions adjacent to corners extending in the third direction among a plurality of corners of the first opposed surface.

In an embodiment, forming the second connection portion may include forming the second connection portion by pressing, by a third pressing member, a region adjacent to a corner opposite the imaginary folding line among the plurality of corners of the first opposed surface.

In an embodiment, forming the first connection portion may include disposing a contacting member to be spaced apart from the imaginary folding line by a predetermined distance in the third direction.

In an embodiment, the contacting member is fixed.

In an embodiment, the method may further include stretching the pouch sheet in a direction toward the contacting member by gas by injecting the gas into the pouch sheet.

In an embodiment, forming the first connection portion may include stretching the pouch sheet by inserting an insertion member into the pouch sheet.

In an embodiment, the method may further include withdrawing the insertion member from the pouch sheet.

In an embodiment, the method may further include sealing the first extension portion, the second extension portion, and the second connection portion.

According to an embodiment of the present disclosure, the stability of a battery cell may be improved.

According to another embodiment of the present disclosure, the energy density of a battery cell may be improved.

According to another embodiment of the present disclosure, the efficiency of a battery cell may be improved.

According to another embodiment of the present disclosure, a manufacturing cost of a battery cell may be reduced.

According to another embodiment of the present disclosure, a manufacturing cost of a battery module may be reduced.

According to another embodiment of the present disclosure, a manufacturing cost of a battery pack may be reduced.

According to another embodiment of the present disclosure, the space utilization of a battery module may be improved.

According to another embodiment of the present disclosure, the space utilization of a battery pack may be improved.

### BRIEF DESCRIPTION OF THE DRAWINGS

FIG. 1 is a diagram illustrating a battery cell according to the present disclosure;

FIG. 2 is an enlarged view of a part of a battery cell according to the present disclosure;

FIG. 3 is an enlarged view of a part of a battery cell according to the present disclosure;

FIGS. 4A to 4C are diagrams illustrating a method for manufacturing a pouch case according to the present disclosure;

FIGS. 5A to 5D are diagrams illustrating a method for manufacturing a pouch case according to the present disclosure;

FIG. 6 is a flowchart illustrating a method for manufacturing a battery cell according to the present disclosure; and

FIG. 7 is a diagram illustrating a battery cell according to the present disclosure.

### DETAILED DESCRIPTION

Specific terms in this specification are merely used for convenience of illustration, and are not used to limit embodiments provided herein.

For example, expressions such as “sameness” and “same” indicate not only a state of being strictly the same, but also a state in which there is a tolerance or a difference to the extent that the same function is obtained.

For example, expressions indicating relative or absolute arrangement such as “in a direction,” “along a direction,” “parallel,” “vertically,” “centrally,” “concentrically,” or “coaxially” not only strictly indicate such arrangement, but also indicate a state of relative displacement with a tolerance or an angle or distance to the extent that the same function is obtained.

Hereinafter, the use of terms such as “first,” “second,” and “third” before the components mentioned below is merely intended to avoid confusion of the components to be referred to, and is not intended to indicate any order, importance, or master-slave relationship between the components. For example, an invention may include only the second component without the first component.

In this specification, singular forms are intended to include plural forms as well, unless the context clearly indicates otherwise.

Hereinafter, embodiments of the present disclosure will be described in detail with reference to the accompanying drawings. The configuration or control methods of a device described below are intended to explain embodiments of the present disclosure and are not intended to limit the scope of the present disclosure. Like reference numerals refer to like elements throughout the specification.

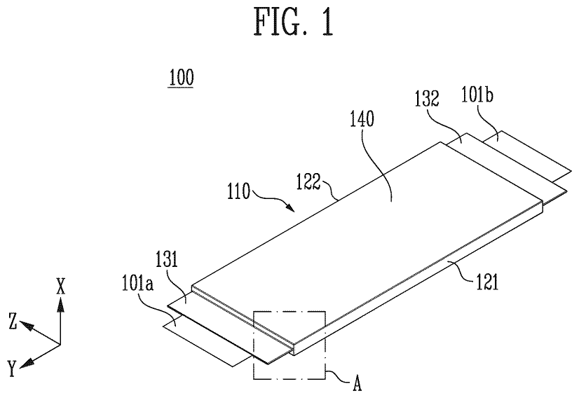

FIG. 1 is a diagram illustrating a battery cell 100 according to the present disclosure.

The battery cell 100 according to an embodiment of the present disclosure may include: an electrode assembly in which a first electrode, a second electrode, and a separator separating the first electrode and the second electrode are stacked in a first direction; a pouch case 110 accommodating the electrode assembly; and a first lead tab portion 101a and a second lead tab portion 101b electrically connected to the electrode assembly, and each protruding outwardly from the pouch case 110 in a second direction which is one of directions perpendicular to the first direction. The pouch case 110 may include: a first opposed surface 140 and a second opposed surface facing each other in the first direction; a first connection portion 121 and a second connection portion 122 disposed in the second direction and connecting the first opposed surface 140 and the second opposed surface; and a first extension portion 131 and a second extension portion 132, wherein the first extension portion 131 extends from the first connection portion 121 and the second connection portion 122 to enclose the first lead tab portion 101a protruding in the second direction, and the second extension portion 132 extends from the first connection portion 121 and the second connection portion 122 to enclose the second lead tab portion 101b protruding in the second direction. A distance from the first connection portion 121 to the second connection portion 122 in a third direction perpendicular to the first direction and the second direction may be greater than or equal to a length of the first extension portion 131 in the third direction.

Referring to FIG. 1, the battery cell 100 according to the present disclosure may include an electrode assembly (not shown), a pouch case 110, and lead tab portions 101a and 101b.

The lead tab portions 101a and 101b may be implemented as a plurality of lead tab portions. The lead tab portions 101a and 101b may include a first lead tab portion 101a and a second lead tab portion 101b.

The battery cell 100 according to the present disclosure may represent a double-ended battery cell in which the first lead tab portion 101a and the second lead tab portion 101b are formed on one side and the other side of the electrode assembly, respectively.

According to an embodiment, the electrode assembly may include a first electrode, a second electrode, and a separator separating the first electrode and the second electrode. According to an embodiment, the first electrode, the second electrode, and the separator may be stacked in a predetermined first direction (an X-axis direction).

According to an embodiment, the separator is disposed between the first electrode and the second electrode to prevent or mitigate a short circuit and allow the movement of lithium ions.

According to an embodiment, the first electrode and the second electrode may represent a cathode and an anode, respectively.

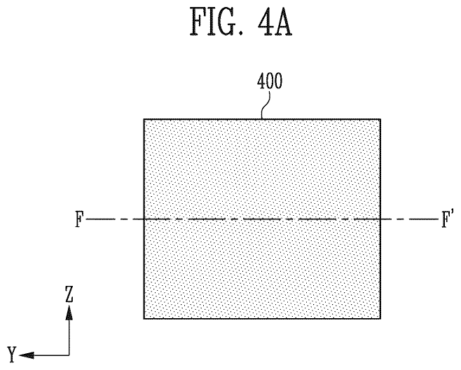

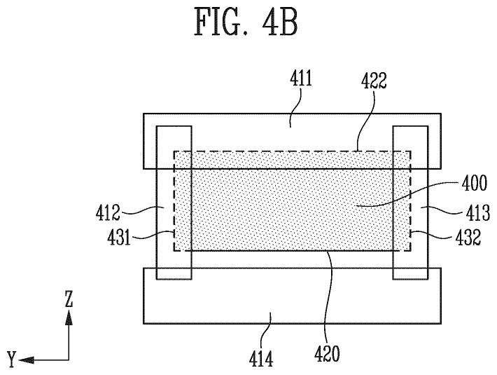

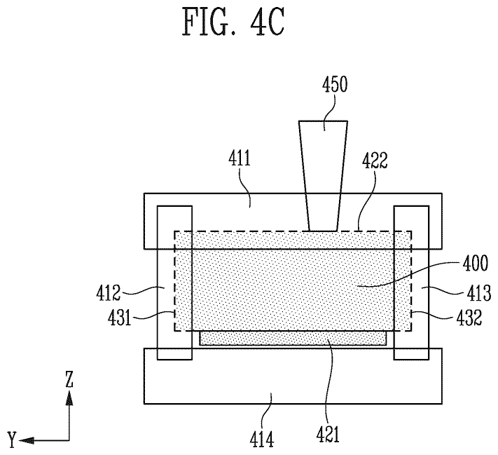

According to an embodiment, the pouch case 110 may accommodate the electrode assembly. The pouch case 110 may be formed by folding and sealing a pouch sheet 400 of FIG. 4A.

According to an embodiment, the first lead tab portion 101a is electrically connected to the electrode assembly and may protrude outwardly from the pouch case 110 in a second direction (a Y-axis direction), which is perpendicular to the first direction (the X-axis direction).

According to an embodiment, the second lead tab portion 101b is electrically connected to the electrode assembly and may protrude outwardly from the pouch case 110 in the second direction (the Y axis-direction).

According to an embodiment, the pouch case 110 may include a first opposed surface 140 and a second opposed surface (not shown) facing each other in the first direction (the X-axis direction). The first opposed surface 140 is an upper surface of the pouch case 110 and may be a surface symmetrical to the second opposed surface. The second opposed surface is a lower surface of the pouch case 110 and may be a surface symmetrical to the first opposed surface 140.

According to an embodiment, the pouch case 110 may include connection portions 121 and 122 disposed in the second direction (the Y-axis direction). The connection portions 121 and 122 may be implemented as a plurality of connection portions. The connection portions 121 and 122 may include a first connection portion 121 and a second connection portion 122. According to an embodiment, the first connection portion 121 and the second connection portion 122 may be surfaces facing each other. According to an embodiment, the first connection portion 121 and the second connection portion 122 may connect the first opposed surface 140 and the second opposed surface. According to an embodiment, the first connection portion 121 and the second connection portion 122 may be side surfaces of the pouch case 110.

According to an embodiment, the first opposed surface 140, the second opposed surface, and the first connection portion 121 may be formed by folding the pouch sheet 400.

According to an embodiment, the pouch case 110 may include extension portions 131 and 132 extending from the connection portions 121 and 122 to enclose the lead tab portions 101a and 101b. The extension portions 131 and 132 may be implemented as a plurality of extension portions. According to an embodiment, the pouch case 110 may include a first extension portion 131 and a second extension portion 132 extending from the first connection portion 121 and the second connection portion 122. According to an embodiment, the first extension portion 131 may enclose the first lead tab portion 101a protruding in the second direction (the Y-axis direction). The first lead tab portion 101a may pass through the first extension portion 131 and protrude outwardly from the pouch case 110. According to an embodiment, the second extension portion 132 may enclose the second lead tab portion 101b protruding in the second direction (the Y-axis direction). The second lead tab portion 101b may pass through the second extension portion 132 and protrude outwardly from the pouch case 110.

According to an embodiment, the first extension portion 131, the second extension portion 132, and the second connection portion 122 may be sealed.

In the battery cell 100 according to the present disclosure, when the three sides of the pouch case are sealed, protruding portions at opposite ends of an unsealed side might not be formed. The protruding portion may be referred to as a shark-fin or bat ear.

The battery cell 100 according to the present disclosure might not have a protruding portion. For example, in the battery cell 100 according to the present disclosure, the first extension portion 131 might not protrude farther than the first connection portion 121 in a third direction (a Z-axis direction) perpendicular to the first direction and the second direction. For example, in the battery cell 100 according to the present disclosure, the second extension portion 132 might not protrude farther than the first connection portion 121 in the third direction (the Z-axis direction) perpendicular to the first direction and the second direction.

Accordingly, in the battery cell 100 of the present disclosure, the first extension portion 131 and the second extension portion 132 do not protrude farther than the first connection portion 121 in the third direction (the Z-axis direction), thereby being capable of improving the energy density in the battery cell 100.

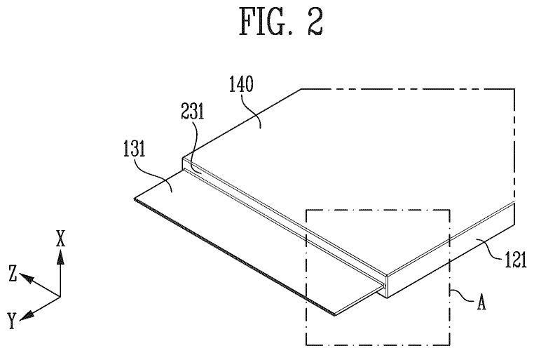

FIG. 2 is an enlarged view of a part of the battery cell 100 according to the present disclosure.

Referring to FIG. 2, when the pouch sheet 400 of FIG. 4A is pressed using a first pressing member 412 of FIG. 4B, the first extension portion 131, a first step portion 231 connecting the first extension portion 131 and the first opposed surface 140, and a second step portion (not shown) connecting the first extension portion 131 and the second opposed surface (not shown) may be formed.

The angle formed between the first step portion 231 and the first opposed surface 140 may be a right angle. The angle formed between the first step portion 231 and the first extension portion 131 may be a right angle.

The angle formed between the second step portion and the second opposed surface may be a right angle. The angle formed between the second step portion and the first extension portion 131 may be a right angle.

Although the second extension portion 132 is not shown in FIG. 2, the description of the first extension portion 131 may also be applied to the second extension portion 132 in the same manner. When the pouch sheet 400 of FIG. 4A is pressed using a second pressing member 413 of FIG. 4B, the second extension portion 132, a third step portion connecting the second extension portion 132 and the first opposed surface 140, and a fourth step portion connecting the second extension portion 132 and the second opposed surface (not shown) may be formed.

The angle formed between the third step portion and the first opposed surface 140 may be a right angle. The angle formed between the third step portion and the second extension portion 132 may be a right angle.

The angle formed between the fourth step portion and the second opposed surface may be a right angle. The angle formed between the fourth step portion and the second extension portion 132 may be a right angle.

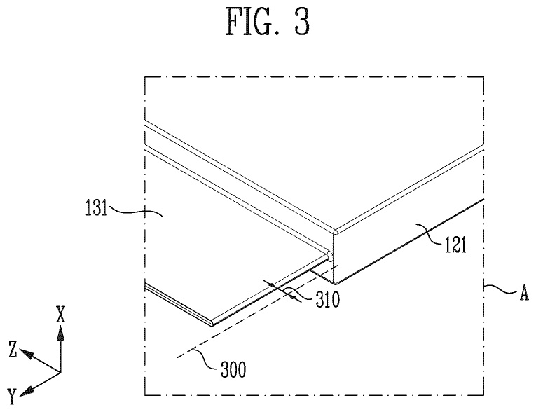

FIG. 3 is an enlarged view of a part of the battery cell 100 according to the present disclosure.

More specifically, FIG. 3 is an enlarged view of a region including portion A of FIGS. 1 and 2.

The first extension portion 131 might not protrude farther in the third direction (the Z-axis direction) than an imaginary line 300 extending from the first connection portion 121 in the second direction (the Y-axis direction).

A minimum distance 310 in the third direction (the Z-axis direction) between the imaginary line 300 extending from the first connection portion 121 in the second direction (the Y-axis direction) and the first extension portion 131 may be 10 mm or less. However, this is only an example, and the numerical value of the minimum distance 310 might not be limited thereto.

Although not shown in FIG. 3, the second extension portion 132 might not protrude farther in the third direction (the Z-axis direction) than the imaginary line 300 extending from the first connection portion 121 in the second direction (the Y-axis direction).

The minimum distance in the third direction (the Z-axis direction) between the imaginary line 300 extending from the first connection portion 121 in the second direction (the Y-axis direction) and the second extension portion 132 may be 10 mm or less. However, this is only an example, and the numerical value of the minimum distance might not be limited thereto.

FIGS. 4A to 4C are diagrams illustrating a method for manufacturing a pouch case according to the present disclosure.

Referring to FIG. 4A, the pouch sheet 400 according to the present disclosure may be folded in the third direction (the Z-axis direction) along imaginary folding line F-F′ extending in the second direction (the Y-axis direction).

Referring to FIG. 4B, according to an embodiment, the first pressing member 412 and the second pressing member 413 may be disposed in regions including and adjacent to corners 431 and 432 extending in the third direction (the Z-axis direction) among a plurality of corners 422, 431, 432, and 420 of the pouch sheet 400. According to an embodiment, the first pressing members 412 and the second pressing member 413 may press the regions including and adjacent to the corners 431 and 432, thereby forming the first extension portion 131 and the second extension portion 132.

According to an embodiment, a third pressing member 411 may be disposed in a region including and adjacent to the corner 422 opposite imaginary folding line F-F′ among the plurality of corners 422, 431, 432, and 420 of the pouch sheet 400. According to an embodiment, the third pressing member 411 may press the region including and adjacent to the corner 422, thereby forming the second connection portion 122.

According to an embodiment, a contacting member 414 may be disposed at a position spaced apart from the corner 420 corresponding to imaginary folding line F-F′ by a predetermined distance. The contacting member 414 may be disposed in a direction away from the pouch sheet 400 in the third direction (the Z-axis direction).

According to an embodiment, the contacting member 414 may be fixed and non-movable.

Referring to FIG. 4C, according to an embodiment, an injection device 450 for injecting gas into the pouch sheet 400 may be disposed.

According to an embodiment, gas is injected into the pouch sheet 400 by the injection device 450, causing the pouch sheet 400 to expand in a direction toward the contacting member 414 by the gas. An expanded portion 421 may represent the first connection portion 121.

Alternatively, gas may be injected into the pouch sheet 400 by the injection device 450, causing the pouch sheet 400 to stretch in the direction toward the contacting member 414 by the gas. The stretched portion 421 may represent the first connection portion 121.

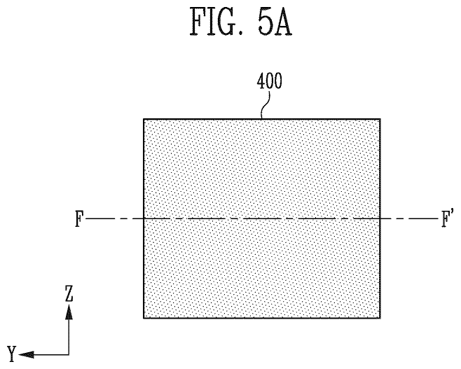

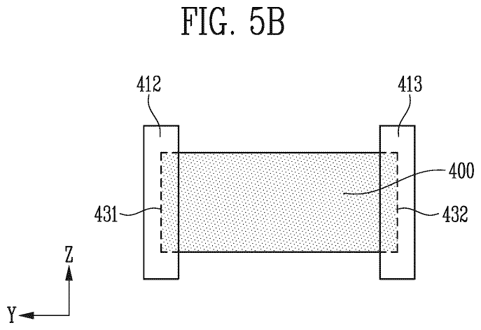

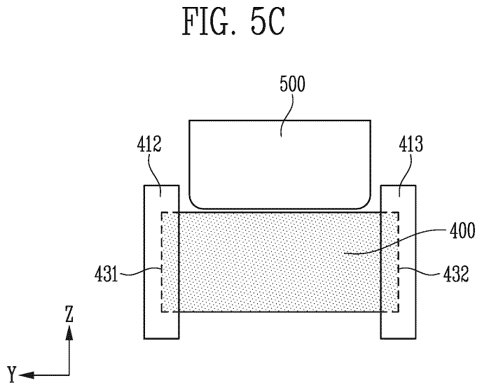

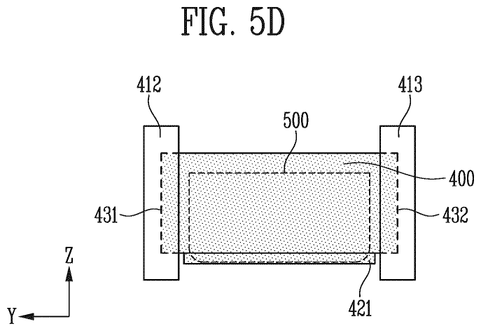

FIGS. 5A to 5D are diagrams illustrating a method for manufacturing a pouch case according to the present disclosure.

Referring to FIG. 5A, the pouch sheet 400 according to the present disclosure may be folded in the third direction (the Z-axis direction) along imaginary folding line F-F′ extending in the second direction (the Y-axis direction).

Referring to FIG. 5B, according to an embodiment, the first pressing member 412 and the second pressing member 413 may be disposed in regions including and adjacent to the corners 431 and 432 extending in the third direction (the Z-axis direction) among the plurality of corners 422, 431, 432, and 420 of the pouch sheet 400. According to an embodiment, the first pressing member 412 and the second pressing member 413 may press the regions including and adjacent to the corners 431 and 432, thereby forming the first extension portion 131 and the second extension portion 132.

Referring to FIG. 5C, according to an embodiment, an insertion member 500 may be inserted into the pouch sheet 400.

According to an embodiment, the length of the insertion member 500 in the second direction (the Y-axis direction) may be less than or equal to the length of the corner 420 corresponding to folding line F-F′.

Referring to FIG. 5D, according to an embodiment, the insertion member 500 may stretch the pouch sheet 400. The stretched portion 421 may represent the first connection portion 121.

Subsequently, according to an embodiment, the insertion member 500 may be withdrawn from the pouch sheet 400.

Although not shown, subsequently, according to an embodiment, the third pressing member 411 may be disposed in the region including and adjacent to the corner 422 opposite imaginary folding line F-F′ among the plurality of corners 422, 431, 432, and 420 of the pouch sheet 400. According to an embodiment, the third pressing member 411 may press the region including and adjacent to the corner 422, thereby forming the second connection portion 122.

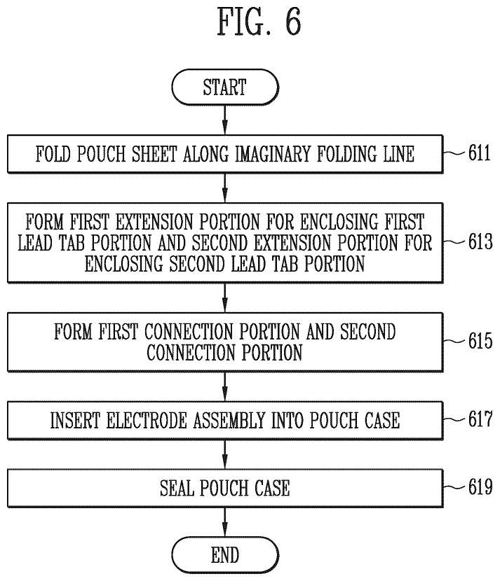

FIG. 6 is a flowchart illustrating a method for manufacturing the battery cell 100 according to the present disclosure.

A method for manufacturing the battery cell 100 according to an embodiment of the present disclosure may be provided. The battery cell 100 may include an electrode assembly in which a first electrode, a second electrode, and a separator separating the first electrode and the second electrode are stacked in a first direction; a pouch case 110 accommodating the electrode assembly; and a first lead tab portion 101a and a second lead tab portion 101b electrically connected to the electrode assembly, and each protruding outwardly from the pouch case in a second direction which is one of directions perpendicular to the first direction. The method for manufacturing the battery cell 100 may include: folding a pouch sheet along an imaginary folding line extending in the second direction, wherein a first opposed surface 140 and a second opposed surface facing each other in the first direction are formed by folding the pouch sheet; forming a first extension portion which encloses the first lead tab portion protruding in the second direction and a second extension portion which encloses the second lead tab portion 101b protruding in the second direction; forming a first connection portion 121 and a second connection portion 122 which connect the first opposed surface 140 and the second opposed surface by stretching the pouch sheet in a third direction perpendicular to the first direction and the second direction, wherein a distance from the first connection portion 121to the second connection portion 122 in the third direction is greater than or equal to a length of the first extension portion 131 in the third direction; and inserting the electrode assembly into the pouch case.

Referring to FIG. 6, the method for manufacturing the battery cell 100 according to the present disclosure may include operation 611 of folding the pouch sheet 400 along imaginary folding line F-F′. According to an embodiment, when the pouch sheet 400 is folded along imaginary folding line F-F′, the first opposed surface 140 and the second opposed surface (not shown) facing each other in the first direction (the X-axis direction) may be formed.

The method for manufacturing the battery cell 100 according to the present disclosure may include operation 613 of forming the first extension portion 131 for enclosing the first lead tab portion 101a and the second extension portion 132 for enclosing the second lead tab portion 101b. The method for manufacturing the battery cell 100 according to the present disclosure may include an operation of pressing, by a pressing member, regions including and adjacent to corners extending in the third direction (the Z-axis direction) among a plurality of corners of the first opposed surface 140.

The method for manufacturing the battery cell 100 according to the present disclosure may include operation 615 of forming the first connection portion 121 and the second connection portion 122.

According to an embodiment, an operation of forming the second connection portion 122 may include an operation of forming the second connection portion 122 by pressing, by a pressing member, a region including and adjacent to a corner opposite imaginary folding line F-F′ among the plurality of corners of the first opposed surface 140.

According to an embodiment, an operation of forming the first connection portion 121 may include an operation of disposing the contacting member 414 to be spaced apart from imaginary folding line F-F′ by a predetermined distance in a direction away from imaginary folding line F-F′ in the third direction (the Z-axis direction). According to an embodiment, the operation of forming the first connection portion 121 may include an operation of forming the first connection portion 121 by injecting gas into the pouch sheet 400 so that the pouch sheet 400 expands (or stretches) in a direction toward the contacting member 414 by the gas. According to an embodiment, the contacting member 414 may be fixed.

Alternatively, according to an embodiment, the operation of forming the first connection portion 121 may include an operation of forming the first connection portion 121 by inserting the insertion member 500 into the pouch sheet 400 such that the pouch sheet 400 is stretched in the direction away from imaginary folding line F-F′ in the third direction (the Z-axis direction). The method for manufacturing the battery cell 100 according to the present disclosure may include an operation of withdrawing the insertion member 500 from the pouch sheet 400 after the first connection portion 121 is formed.

According to an embodiment, the distance between the first connection portion 121 and the second connection portion 122 in the third direction (the Z-axis direction) may be greater than or equal to the maximum distance from the first connection portion 121 to the first extension portion 131 in the third direction (the Z-axis direction). According to an embodiment, the difference between the distance from the first connection portion 121 to the second connection portion 122 and the maximum distance from the first connection portion 121 to the first extension portion 131 may be 10 mm or less.

A method for manufacturing the battery cell 100 according to the present disclosure may include operation 617 of inserting an electrode assembly into the pouch case 110. According to an embodiment, in a state where the first opposed surface 140 and the second opposed surface of the pouch case 110 are disposed at a predetermined angle, the electrode assembly may be inserted into an internal receiving space of the pouch case 110.

The method for manufacturing the battery cell 100 according to the present disclosure may include operation 619 of sealing the pouch case 110. According to an embodiment, the first extension portion 131, the second extension portion 132, and the second connection portion 122 may be sealed.

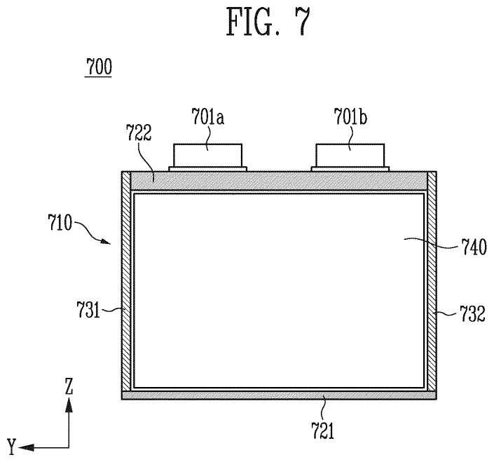

FIG. 7 is a diagram illustrating a battery cell 700 according to the present disclosure. According to an embodiment, the descriptions of the battery cell 100 with reference to FIGS. 1 to 6 may also be applied to the battery cell 700 in FIG. 7 in the same manner.

Referring to FIG. 7, the battery cell 700 according to the present disclosure may include an electrode assembly (not shown), a pouch case 710, and lead tab portions 701a and 701b. More specifically, FIG. 7 is a view of the battery cell 700 as seen from the predetermined first direction (the X-axis direction).

The lead tab portions 701a and 701b may include a first lead tab portion 701a and a second lead tab portion 701b.

The battery cell 700 according to the present disclosure may represent a single-ended battery cell in which the first lead tab portion 701a and the second lead tab portion 701b are formed on one side of the electrode assembly.

According to an embodiment, the electrode assembly may include a first electrode, a second electrode, and a separator separating the first electrode and the second electrode. According to an embodiment, the first electrode, the second electrode, and the separator may be stacked in the predetermined first direction (the X-axis direction). According to an embodiment, the predetermined first direction (the X-axis direction) may represent a direction perpendicular to both the second direction (the Y-axis direction) and the third direction (the Z-axis direction).

According to an embodiment, the separator is disposed between the first electrode and the second electrode to prevent or mitigate a short circuit and allow the movement of lithium ions.

According to an embodiment, the first electrode and the second electrode may represent a cathode and an anode, respectively.

According to an embodiment, the pouch case 710 may accommodate the electrode assembly.

According to an embodiment, the first lead tab portion 701a and the second lead tab portion 701b may be electrically connected to the electrode assembly and may protrude outwardly from the pouch case 710 in the third direction (the Z-axis direction), which is one of the directions perpendicular to the first direction (the X-axis direction).

According to an embodiment, the pouch case 710 may include a first opposed surface 740 and a second opposed surface (not shown) facing each other in the first direction (the X-axis direction). The first opposed surface 740 is an upper surface of the pouch case 710 and may be a surface symmetrical to the second opposed surface. The second opposed surface is a lower surface of the pouch case 710 and may be a surface symmetrical to the first opposed surface 740.

According to an embodiment, the pouch case 710 may include a connection portion 721 disposed in the second direction (the Y-axis direction). According to an embodiment, the pouch case 710 may include side portions 731 and 732 disposed in the third direction (the Z-axis direction). The side portions 731 and 732 may include a first side portion 731 and a second side portion 732.

According to an embodiment, the connection portion 721 and the side portions 731 and 732 may connect the first opposed surface 740 and the second opposed surface.

According to an embodiment, the first opposed surface 740, the second opposed surface, and the connection portion 721 may be formed by folding a pouch sheet.

According to an embodiment, the pouch case 710 may include an extension portion 722 extending from the first opposed surface 740 and the second opposed surface to enclose the lead tab portions 701a and 701b.

According to an embodiment, the extension portion 722 may enclose the lead tab portions 701a and 701b protruding in the third direction (the Z-axis direction). The lead tab portions 701a and 701b may pass through the extension portion 722 and protrude outwardly from the pouch case 710.

According to an embodiment, the side portions 731 and 732, and the extension portion 722 may be sealed.

The battery cell 700 according to the present disclosure might not have protruding portions. For example, in the third direction, the first side portion 731 might not protrude farther than the connection portion 721. For example, in the third direction perpendicular to the first direction and the second direction, the second side portion 732 might not protrude farther than the connection portion 721. Accordingly, the energy density in the battery cell 700 may be improved.

According to an embodiment, the connection portion 721 may be formed by folding the pouch sheet 400 along an imaginary folding line and injecting gas into the pouch sheet 400, thereby stretching the pouch sheet 400 in the third direction (the Z-axis direction). Alternatively, according to an embodiment, the connection portion 721 may be formed by folding the pouch sheet 400 along the imaginary folding line and inserting the insertion member 500 into the pouch sheet 400, thereby stretching the pouch sheet 400 in the third direction (the Z-axis direction).

According to an embodiment, the side portions 731 and 732 may be formed by pressing, by the first pressing member 412 and the second pressing member 413, regions including and adjacent to corners extending in the third direction (the Z-axis direction) among a plurality of corners of the first opposed surface 740.

According to an embodiment, the extension portion 722 may be formed by pressing, by the third pressing member 411, a region including and adjacent to a corner opposite the imaginary folding line among the plurality of corners of the first opposed surface 740.

Because the present disclosure may be implemented in various forms, the scope of the present disclosure is not limited to the above-described embodiments. Accordingly, if modified embodiments include components of the appended claims of the present disclosure, such embodiments should be construed as included within the scope of the present disclosure.

What is claimed is:

1. A battery cell comprising:
an electrode assembly in which a first electrode, a second electrode, and a separator separating the first electrode and the second electrode are stacked in a first direction;
a pouch case accommodating the electrode assembly; and
a first lead tab portion and a second lead tab portion electrically connected to the electrode assembly, and each protruding outwardly from the pouch case in a second direction which is one of directions perpendicular to the first direction,
wherein the pouch case comprises:
a first opposed surface and a second opposed surface facing each other in the first direction;
a first connection portion and a second connection portion disposed in the second direction and connecting the first opposed surface and the second opposed surface; and
a first extension portion and a second extension portion, wherein the first extension portion extends from the first connection portion and the second connection portion to enclose the first lead tab portion protruding in the second direction, and the second extension portion extends from the first connection portion and the second connection portion to enclose the second lead tab portion protruding in the second direction, and
wherein a distance from the first connection portion to the second connection portion in a third direction perpendicular to the first direction and the second direction is greater than or equal to a length of the first extension portion in the third direction.

2. The battery cell of claim 1, wherein each of a minimum distance between the first connection portion and the first extension portion in the third direction, and a minimum distance between the second connection portion and the first extension portion in the third direction is 10 mm or less.

3. The battery cell of claim 1, wherein the first extension portion, the second extension portion, and the second connection portion are sealed.

4. The battery cell of claim 1, wherein the first opposed surface, the second opposed surface, and the first connection portion are formed by folding a pouch sheet.

5. The battery cell of claim 1, wherein the pouch case further comprises:
a first step portion connecting the first extension portion and the first opposed surface; and
a second step portion connecting the first extension portion and the second opposed surface.

6. The battery cell of claim 5, wherein an angle formed between the first step portion and the first opposed surface is a right angle, and
wherein an angle formed between the second step portion and the second opposed surface is a right angle.

7. A method for manufacturing a battery cell,
wherein the battery cell comprises:
an electrode assembly in which a first electrode, a second electrode, and a separator separating the first electrode and the second electrode are stacked in a first direction;
a pouch case accommodating the electrode assembly; and
a first lead tab portion and a second lead tab portion electrically connected to the electrode assembly, and each protruding outwardly from the pouch case in a second direction which is one of directions perpendicular to the first direction, and
wherein the method comprises:
folding a pouch sheet along an imaginary folding line extending in the second direction, wherein a first opposed surface and a second opposed surface facing each other in the first direction are formed by folding the pouch sheet;
forming a first extension portion which encloses the first lead tab portion protruding in the second direction and a second extension portion which encloses the second lead tab portion protruding in the second direction;
forming a first connection portion and a second connection portion which connect the first opposed surface and the second opposed surface by stretching the pouch sheet in a third direction perpendicular to the first direction and the second direction, wherein a distance from the first connection portion to the second connection portion in the third direction is greater than or equal to a length of the first extension portion in the third direction; and
inserting the electrode assembly into the pouch case.

8. The method of claim 7, wherein forming the first extension portion and the second extension portion includes pressing, by a first pressing member and a second pressing member, regions adjacent to corners extending in the third direction among a plurality of corners of the first opposed surface.

9. The method of claim 8, wherein forming the second connection portion includes forming the second connection portion by pressing, by a third pressing member, a region adjacent to a corner opposite the imaginary folding line among the plurality of corners of the first opposed surface.

10. The method of claim 9, wherein forming the first connection portion includes disposing a contacting member to be spaced apart from the imaginary folding line by a predetermined distance in the third direction.

11. The method of claim 10, wherein the contacting member is fixed.

12. The method of claim 11, further comprising stretching the pouch sheet in a direction toward the contacting member by gas by injecting the gas into the pouch sheet.

13. The method of claim 8, wherein forming the first connection portion includes stretching the pouch sheet by inserting an insertion member into the pouch sheet.

14. The method of claim 13, further comprising withdrawing the insertion member from the pouch sheet.

15. The method of claim 7, further comprising sealing the first extension portion, the second extension portion, and the second connection portion.
